(19) United States
(12) Patent Application Publication
(10) Pub. No.: US 2003/0070002 A1
(43) Pub. Date: Apr. 10, 2003

(54) System and method for manipulating HAVi specification virtual key data

(76) Inventor: Henry Fang, Cerritos, CA (US)

Correspondence Address: David C. Ripma, Patent Counsel, Sharp Laboratories of America, Inc., 5750 NW Pacific Rim Boulevard, Camas, WA, 98607, US

(21) Appl. No.: 09/944,685

(22) Filed: Aug. 31, 2001

(51) Int. Cl. G06F 9/00

(52) U.S. Cl. 709/328

(57) ABSTRACT

Methods are provided for the maintaining HEventRepresentation virtual keys in a device using HAVi specification protocols. The first method comprising: from a HAVi level two (L2) graphical user interface (GUI), accessing a JAR file; and, in response to accessing the JAR file from read only memory (ROM), retrieving virtual key information as a static class or data array. The second method comprises: from a HAVi L2 GUI, accessing a Java input/output (I/O) ResourceBundle; and, in response to accessing the ResourceBundle, retrieving virtual key information stored in an I/O device such as a hard disk or Flash memory. The third method comprises: from a HAVi L2 GUI, calling a Java native interface (JNI); at the JNI, using Java byte codes to call a storage driver; from the storage driver, accessing a mapped memory stored in binary format in an electrically erasable programmable read only memory (EEPROM); and, in response to accessing the mapped memory, retrieving virtual key information.

### BACKGROUND OF THE INVENTION

1. Field of the Invention

This invention generally relates to home audiovisual systems and, more particularly, to a method for storing and accessing HAVi compliant virtual key event representation information.

2. Description of the Related Art

As noted in U.S. Pat. No. 6,032,202 (Lea), a typical home audiovisual equipment set up includes a number of components. For example, a radio receiver, a CD player, a pair of speakers, a television, a VCR, a tape deck, and alike. Each of these components is connected to each other via a set of wires. One component is usually the central component of the home audiovisual system. This is usually the radio receiver, or the tuner. The tuner has a number of specific inputs for coupling the other components. The tuner has a corresponding number of control buttons or control switches that provide a limited degree of controllability and interoperability for the components. The control buttons and control switches are usually located on the front of the tuner. In many cases, some, or all, of these buttons and switches are duplicated on a hand held remote control unit. A user controls the home audiovisual system by manipulating the buttons and switches on the front of the tuner, or alternatively, manipulating buttons on the hand held remote control unit.

This conventional home audiovisual system paradigm has become quite popular. As consumer electronic devices become more capable and more complex, the demand for the latest and most capable devices has increased. As new devices emerge and become popular, the devices are purchased by consumers and “plugged” into their home audiovisual systems. Generally, the latest and most sophisticated of these devices are quite expensive (e.g., digital audio tape recorders, DVD players, digital camcorders, and alike). As a consumer purchases new devices, most often, the new device is simply plugged into the system alongside the pre-existing, older devices (e.g., cassette tape deck, CD player, and the like). The new device is plugged into an open input on the back of the tuner, or some other device couple to the tuner. The consumer (e.g., the user) controls the new device via the control buttons on the tuner, via the control buttons and control switches on the front of the new device itself, or via an entirely new, separate, respective remote control unit for the new device.

As the number of new consumer electronics devices for the home audiovisual system have grown and as the sophistication and capabilities of these devices have increased, a number of problems with the conventional paradigm have emerged. One such problem is incompatibility between devices in the home audiovisual system. Consumer electronic devices from one manufacturer often couple to an audiovisual system in a different manner than similar devices from another manufacturer. For example, a tuner made by one manufacturer may not properly couple with a television made by another manufacturer.

In addition, if one device is much newer than another device, additional incompatibilities may exist. For example, a new device might incorporate hardware (e.g., specific inputs and outputs) that enables more sophisticated remote control functions. This hardware may be unusable with older devices within the system. Or, for example, older tuners may lack suitable inputs for some newer devices (e.g., mini-disc players, VCRs, etc.), or may lack enough inputs for all devices of the system.

Another problem is the lack of functional support for differing devices within an audiovisual system. For example, even though a television may support advanced sound formats (e.g., surround sound, stereo, etc.), if an older less capable tuner does not support such functionality, the benefits of the advanced sound formats can be lost.

Another problem is the proliferation of controls for the new and differing devices within the home audiovisual system. For example, similar devices from different manufacturers can each have different control buttons and control switch formats for accomplishing similar tasks (e.g., setting the clock on a VCR, programming a VCR record a later program, and alike). In addition, each new device coupled to the audiovisual system often leads to another dedicated remote control unit for the user to keep track of and learn to operate.

The emergence of networking and interface technology (e.g., IEEE 1394 serial communication bus and the wide spread adoption of digital systems) offers prospects for correcting these problems. Further, an alliance of manufactures has agreed to an open, extensible architecture to provide for intelligent, self configuring, easily extensible devices or AV systems.

It should be noted that the home AV interoperability (HAVi) architecture of the present invention is an open, platform-independent, architecturally-neutral network that allows consumer electronics manufacturers and producers to provide inter-operable appliances. It can be implemented on different hardware/software platforms and does not include features that are unique to any one platform. The interoperability interfaces of the HAVi architecture are extensible and can be added to, modified, and advanced as market requirements and technology change. They provide the infrastructure to control the routing and processing of isochronous and time-sensitive data (e.g., such as audio and video content).

Specifically, the HAVi architecture provides: an execution environment supporting the visual representation and control of appliances; application and system services; and communication mechanisms for extending the environment dynamically through plug and play or otherwise.

The underlying structure for such a network consists of set of interconnected clusters of appliances. Typically, there will be several clusters in the home, with one per floor, or per room. Each cluster will work as a set of interconnected devices to provide a set of services to users. Often, one device will act as a controller for a set of other devices. However, the architecture is sufficiently flexible to also allow a home to consist of a single cluster with no master controller.

The level two (L2) graphical user interface (GUI) of HAVi system includes an application program interface (API) called HEventRepresentation to identify the characteristics of remote control, or front panel buttons. A conventional implementation of the HEventRepresentation class API consists of specification compliant portions, that permit interoperation between different devices and manufacturers. However, implementation specific parts of the API can vary for different manufacturers, to highlight certain device characteristics, for example, or for use in creating features by the system user.

In the HAVi system, all the applications that reference the HEventRepresentation API request information concerning a display key or button specified in HAVi specification. These display keys or buttons are referred to herein as virtual keys or keys, since the HEventRepresentation API is typically invoked to provide information, so that a button can be displayed on a TV screen or liquid crystal display (LCD) panel. The HAVi specification suggests that the HEventRepresentation API provide information for the keys shown in Table 1.

The HAVi specification suggests that applications use the HEventRepresentation.getString( ), the HEventRepresentation.getColor( ), and the HEventRepresentation.getSymbol( ) to retrieve information about each event (key) represented in the HAVi system.

TABLE 1
Sample of HEventRepresentation class contents.

| Event | Implied symbol | Sample |
|---|---|---|
| VK_GO_TO_START | Two equilateral triangles, pointing | [symbol] |
| | at a line to the left | |
| VK_REWIND | Two equilateral triangles, pointing | [symbol] |
| | to the left | |
| VK_STOP | A square | [symbol] |
| VK_PAUSE | Two vertical lines, side by side | [symbol] |
| VK_PLAY | One equilateral triangle, pointing | [symbol] |
| | to the right | |
| VK_FAST_FWD | Two equilateral triangles, pointing | [symbol] |
| | to the right | |
| VK_GO_TO_END | Two equilateral triangles, | [symbol] |
| | pointing to a line at the right | |
| VK_TRACK_PREV | One equilateral triangle, pointing | [symbol] |
| | to a line at the left | |
| VK_TRACK_NEXT | One equilateral triangle, pointing | [symbol] |
| | to a line at the right | |
| VK_RECORD | A circle, normally red | [symbol] |
| VK_EJECT_TOGGLE | A line under a wide triangle | [symbol] |
| | which points up | |
| VK_VOLUME_UP | A ramp, increasing to the right, | [symbol] |
| | near a plus sign | |
| VK_VOLUME_DOWN | A ramp, increasing to the right, | [symbol] |
| | near a minus sign | |
| VK_UP | An arrow pointing up | [symbol] |
| VK_DOWN | An arrow pointing down | [symbol] |
| VK_LEFT | An arrow pointing to the left | [symbol] |
| VK_RIGHT | An arrow pointing to the right | [symbol] |
| VK_POWER | A circle, broken at the top, | [symbol] |
| | with a vertical line in the break | |

However, the HAVi specification does not suggest how the key information, shown in Table 1, should be stored. Nor does the specification specify where the information should be stored.

It would be advantageous if a HAVi compliant HEventRepresentation method could be found that permitted the features of particular devices to be highlighted using virtual keys.

It would be advantageous if a HAVi compliant HEventRepresentation method could be found that minimized maintenance costs associated with identifying the table contents to be modified, creating code to use the table, modifying the table contents, and verifying the table content modifications.

It would be advantageous if a HAVi compliant HEventRepresentation method could be found that minimized the amount of memory required to store virtual key information.

It would be advantageous if a HAVi compliant HEventRepresentation method could be found that permitted a designer to make trade-offs between programmability, memory, and maintenance costs.

### SUMMARY OF THE INVENTION

The HAVi specification offers a guideline as to how a class of virtual key representations can be implemented for applications that display virtual keys. The HAVi specification is an implementation guideline, but the actual implementation is dependent upon the platform; the microprocessor system and the software operating system. The actual implementation is also dependent upon specific device features and resource requirements.

Accordingly, a method is provided for the maintaining HEventRepresentation virtual keys in a device using HAVi specification protocols. The method comprises: from a HAVi level two (L2) graphical user interface (GUI), accessing a Java ARchive (JAR) file; and, in response to accessing the JAR file from read only memory (ROM), retrieving virtual key information as a static class or data array.

Alternately, the method comprises: from a HAVi L2 GUI accessing a Java input/output (I/O) ResourceBundle; and, in response to accessing the ResourceBundle, retrieving virtual key information stored in an input/output (I/O) device such as a hard disk or Flash memory.

In yet another alternative, the method comprises: from a HAVi L2 GUI calling a Java native interface (JNI); at the JNI, using Java byte codes to call a storage driver; from the storage driver, accessing a mapped memory stored in binary format in an electrically erasable programmable read only memory (EEPROM); and, in response to accessing the mapped memory, retrieving virtual key information.

Additional details of the maintaining HEventRepresentation virtual keys are provided below.

### BRIEF DESCRIPTION OF THE DRAWING

FIG. 1 is a flowchart illustrating a first method for maintaining HEventRepresentation virtual keys in a device using HAVi specification protocols.

FIG. 2 is a flowchart illustrating a second method for maintaining HEventRepresentation virtual keys in a device using HAVi specification protocols.

FIG. 3 is a flowchart illustrating a third method for maintaining HEventRepresentation virtual keys in a device using HAVi specification protocols.

FIG. 4a is an example property text file virtual key representation.

FIG. 4b depicts the process of using a ResourceBundle to access virtual key information.

FIG. 5 illustrates an example text array virtual key representation.

FIG. 6 is an example of a static class virtual key representation.

FIG. 7 is a representation of a JVM accessing model.

FIG. 8 is a representation of a Java I/O accessing model.

FIG. 9 is a representation of a JNI/storage driver accessing model.

FIG. 10 is an example display of virtual keys created with string data and color data.

FIG. 11 is an example display of virtual keys using symbols data.

### DETAILED DESCRIPTION OF THE PREFERRED EMBODIMENTS

Some portions of the detailed descriptions that follow are presented in terms of procedures, steps, logic blocks, codes, processing, and other symbolic representations of operations on data bits within a microprocessor or memory. These descriptions and representations are the means used by those skilled in the data processing arts to most effectively convey the substance of their work to others skilled in the art. A procedure, microprocessor executed step, application, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a microprocessor device. It has proven convenient at times, principally for reasons of common usage, to refer to these signals as bits, values, elements, symbols, characters, terms, numbers, or the like. Where physical devices, such as a memory are mentioned, they are connected to other physical devices through a bus or other electrical connection. These physical devices can be considered to interact with logical processes or applications and, therefore, are “connected” to logical operations. For example, a memory can store or access code to further a logical operation, or an application can call a code section from memory for execution.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “connecting” or “translating” or “displaying” or “prompting” or “determining” or “displaying” or “recognizing” or the like, refer to the action and processes of in a microprocessor system that manipulates and transforms data represented as physical (electronic) quantities within the computer system's registers and memories into other data similarly represented as physical quantities within the wireless device memories or registers or other such information storage, transmission or display devices.

The present invention is based on HAVi specification V1.1, and, more particularly, the Level 2 User Interface (Chapter 8), which is incorporated herein by reference. The present invention can generally be described as follows:

(1) three data formats for storing event representation (virtual key representation) in the HAVi L2 system;

(2) three media models (devices) to contain data formats described in (1) above; and,

(3) user programmable event representation.

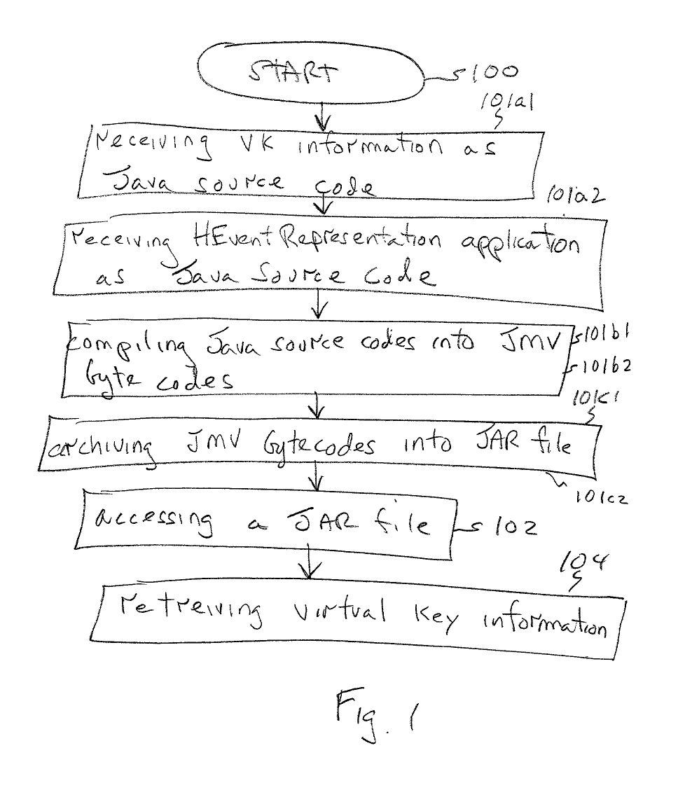

FIG. 1 is a flowchart illustrating a first method for maintaining HEventRepresentation virtual keys in a device using HAVi specification protocols. The maintenance method concerns virtual key information storage and access to the stored information. Although the method, and the methods described below, has been depicted as a sequence of steps for clarity, no order should be inferred from the numbering unless explicitly stated. The method begins at Step 100. Step 102, from a HAVi level two (L2) graphical user interface (GUI), accesses a JAR file. Step 104, in response to accessing the JAR file, retrieves virtual key information.

As is well known, a JAR is a file format used to include all the elements required by a Java application. Downloading is simplified since the files needed to support the “applet” are bundled together with the “applet” (strictly speaking an applet is executed in a browser environment). In the present invention the “applet” can be thought of as the HEventRepresentation application. Once the file is identified, it is downloaded and separated into its components. During the execution of the “applet”, when a new class or data array is requested by the “applet”, it is searched for (first) in the archives associated with the “applet”.

Accessing a JAR file in Step 102 includes accessing a JAR file stored in read only memory (ROM). Retrieving virtual key information in Step 104 includes retrieving virtual key information from a JAR file model selected from the group including static classes and data arrays. Retrieving virtual key information in response to accessing the JAR file in Step 104 also includes retrieving a HEventRepresentation application bundled with the virtual key information.

In some aspects of the invention, a first microprocessor machine using a first operating system is included. Then, the method comprises further steps. Prior to accessing the JAR file in Step 102, the method comprises further steps. Step 101a1 receives virtual key (VK) information as Java source code. Step 101b1, using a Java compiler, compiles the Java source code into Java virtual machine (JVM) byte codes for the first operating system. Step 101c1, using jar tools, archives the JVM byte codes into a JAR file stored in ROM.

Step 101a2 receives the HEventRepresentation application as Java source code. Step 101b2, using a Java compiler, compiles the Java source code into Java virtual machine (JVM) byte codes for the first operating system. Step 101c2, using jar tools, archives the JVM byte codes into a JAR file stored in ROM.

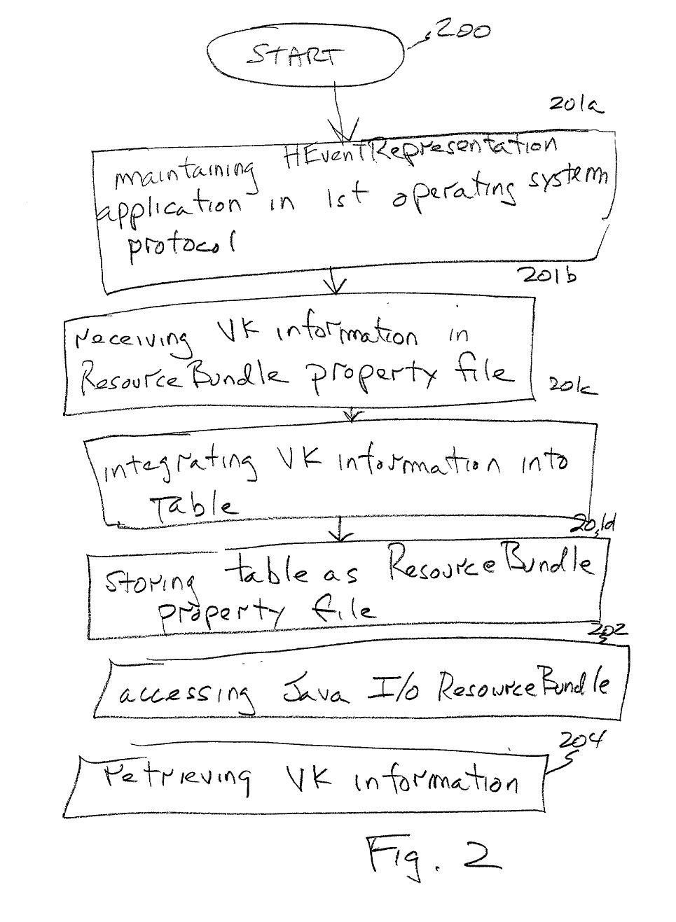

FIG. 2 is a flowchart illustrating a second method for maintaining HEventRepresentation virtual keys in a device using HAVi specification protocols. The method starts at Step 200. Step 202, from a HAVi L2 GUI, accesses a Java input/output (I/O) ResourceBundle. Step 204, in response to accessing the ResourceBundle, retrieves virtual key information. Accessing the ResourceBundle in Step 204 includes using a ResourceBundle API to specify a property file.

A first microprocessor machine using a first operating system is included. Then, the method comprises a further step. Step 201a maintains a HEventRepresentation application in a protocol associated with the first operating system. Accessing the ResourceBundle in Step 204 includes using a ResourceBundle API to specify a property file stored in a file system associated with the first microprocessor machine. Further, using a ResourceBundle API to specify a property file stored in the file system in Step 204 includes specifying a property file stored in an I/O device selected from the group of storage devices including hard disks and Flash memory.

The method comprises further steps. Step 201b receives virtual key information as text-based properties attributes in a ResourceBundle property file. Step 201c integrates the virtual key information into a table of virtual key characteristics. Step 201d stores the virtual key characteristics table as the ResourceBundle property file.

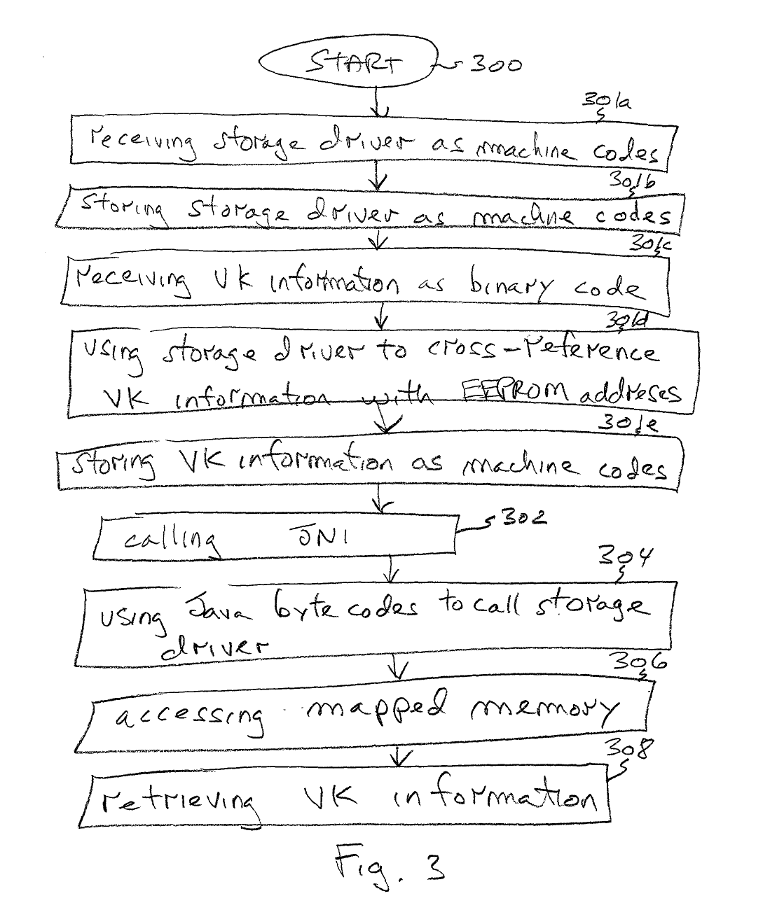

FIG. 3 is a flowchart illustrating a third method for maintaining HEventRepresentation virtual keys in a device using HAVi specification protocols. The method begins at Step 300. Step 302, from a HAVi L2 GUI, calls a Java native interface (JNI). Step 304, at the JNI, uses Java byte codes to call a storage driver. Step 306, from the storage driver, accesses a mapped memory. Step 308, in response to accessing the mapped memory, retrieves virtual key information.

Accessing a mapped memory in Step 306 includes accessing a mapped memory stored in an electrically erasable programmable read only memory (EEPROM). Retrieving virtual key information in Step 308 includes retrieving virtual key information from mapped memory in a binary format.

Using Java byte codes to call a storage driver at the JNI in Step 304 includes converting the Java byte code to binary format addresses. Then, accessing a mapped memory from the storage driver in Step 306 includes using the binary format addresses to access ASCII codes stored in the EEPROM.

A first microprocessor using a first operating system is included. Then, the method comprises further steps. Step 301a receives the storage driver as first operating system machine codes. Step 301b stores the storage driver as machine code. Step 301c receives virtual key information as binary format code. Step 301d, using the storage driver, cross-references the virtual key information with EEPROM addresses. Step 301e stores the virtual key information in the EEPROM as machine code.

The three above-described methods all have advantages that must be evaluated in terms the cost of the products, software maintenance, and storage size, and access speed.

Data Storage Models

For each virtual key event, for example the “record” virtual key (VK_RECORD), there are at least three (3) associated fields to support the HEventRepresentation class. They are: a field for string; a field for symbol; and, a field for color representation. There are several ways of storing these data. They can be stored in text file format, in text array format, or in a static class format.

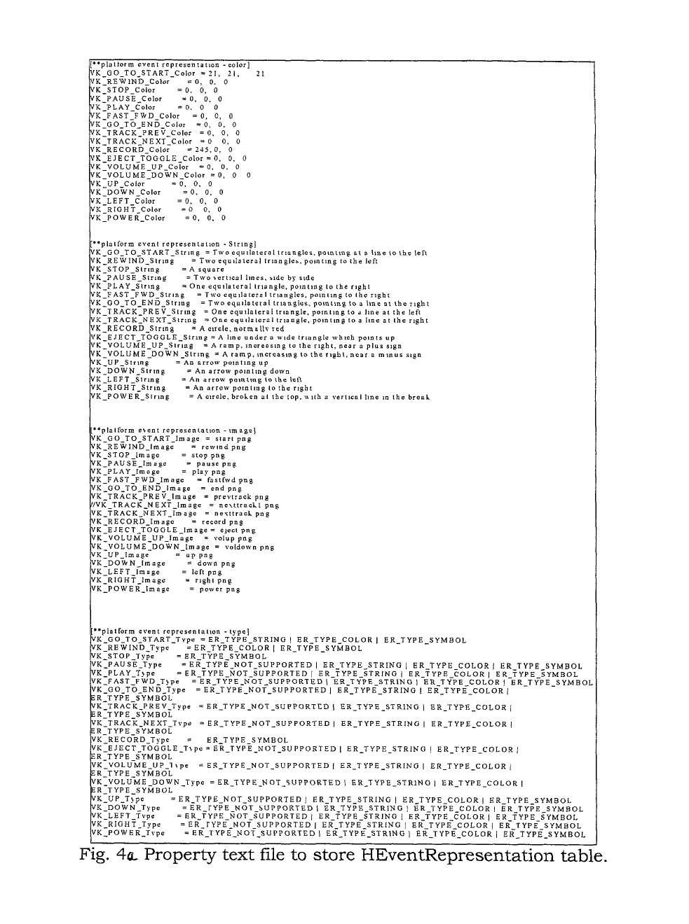

FIG. 4a is an example property text file virtual key representation. A test file format implementation takes advantage of java.awt.ResourceBundle class. With a ResourceBundle class, a resource property file can be established to contain VK_RECORD_color, VK_RECORD_string, VK_RECORD_image, VK_RECORD_type variables that link the virtual key representation to HAVi code implementation. Note that the property file contains the HEventRepresentation class's table, which is not part of the API implementation. The property file can be maintained apart from the API code maintenance.

FIG. 4b depicts the process of using a ResourceBundle to access virtual key (VK) information. A ResourceBundle API specifies a property file and a property attribute (Step 1). The ResourceBundle finds the file and searches for the proper attribute (Step 2). The VK information (“an arrow pointing up”) is returned to the ResourceBundle in Step 3, and to the API in Step 4.

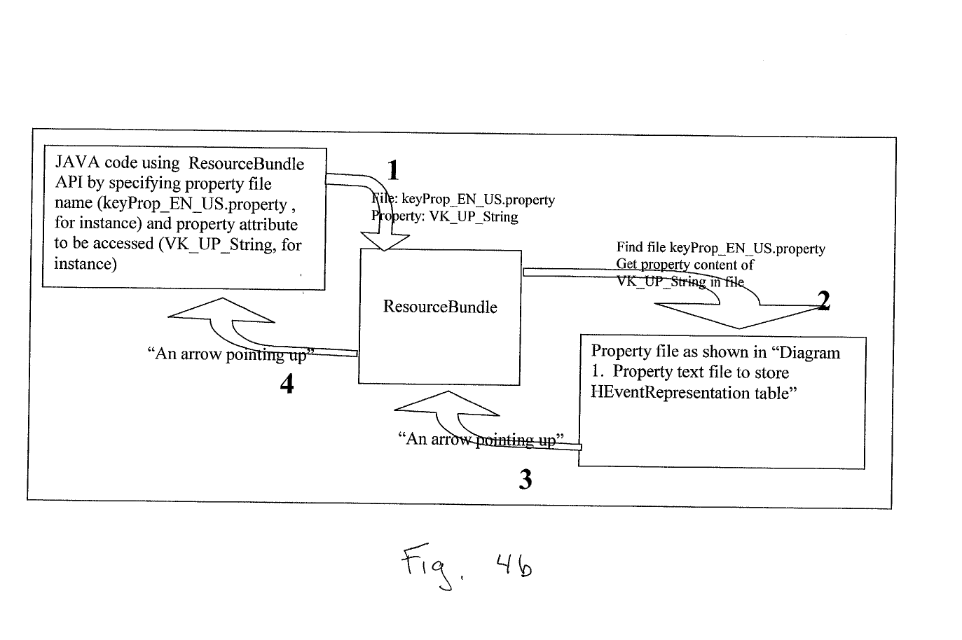

FIG. 5 illustrates an example text array virtual key representation. This storage model is a text array embedded table in an API implementation that recommends the format of storage. The data array contains all the fields for the representation of each key, including key code, color, string representation, and image representation file name. Changes in the key representation table must be made by changing the code. On the other hand, the representation can be stored in a smaller memory due to the binary storage format, as compared to the property text file of FIG. 4 using the text format.

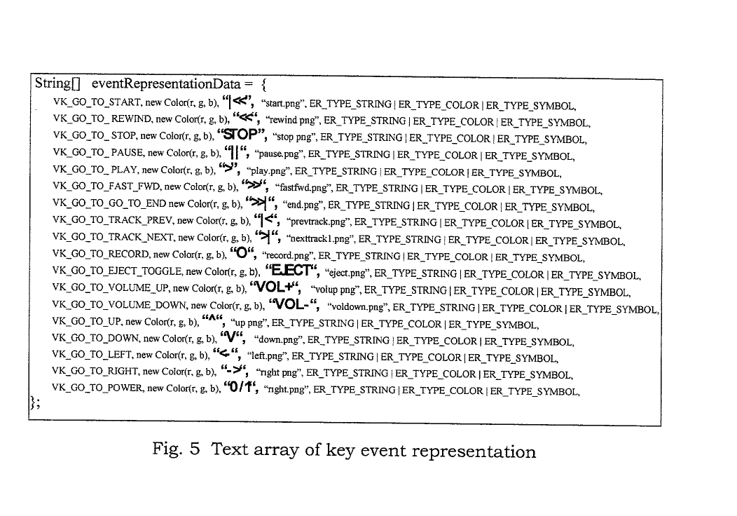

FIG. 6 is an example of a static class virtual key representation. This storage model is similar to the text array of FIG. 5 in that the data storage is part of API implementation. Again, any table changes require a change in code. Each field can be accessed programmatically as: EventRepresentation.VK_GO_TO_START.code, EventRepresentation.VK_PAUSE.s, or EventRepresentation.VK_POWER.imgFile, for example.

Data Accessing Models

The virtual key information in the above-described data storage models can be accessed in several ways. Each access model uses a different java technology.

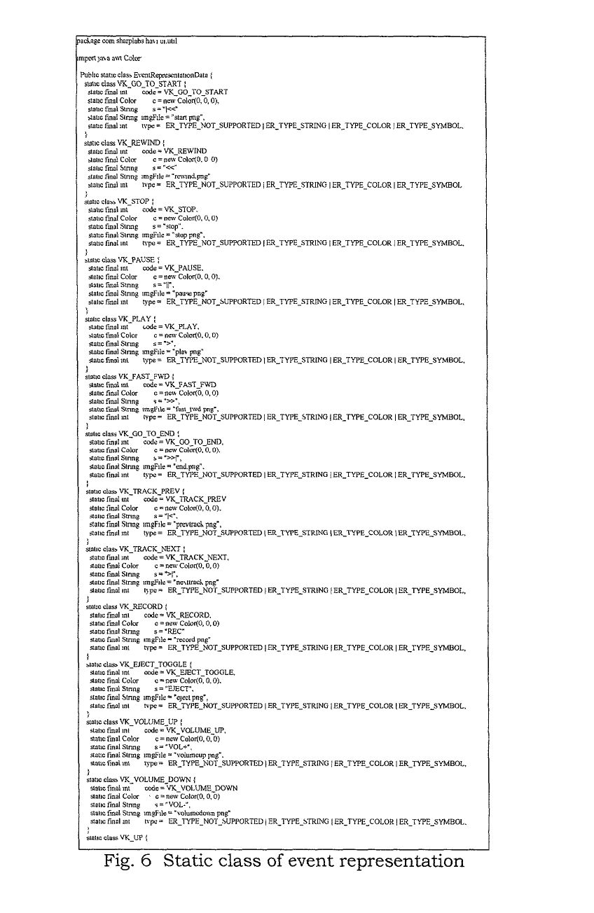

FIG. 7 is a representation of a JVM accessing model. The JVM accessing model embeds event representation data in data array (see FIG. 5) or a static class (see FIG. 6). Data is stored using Java data types such as byte arrays, static classes, and static data members. Access data such as virtual key information is just the same as accessing class data members. This access model has a reasonable maintenance cost and reasonable memory cost. The disadvantage of this model is that event representation updates are difficult to perform by a system user.

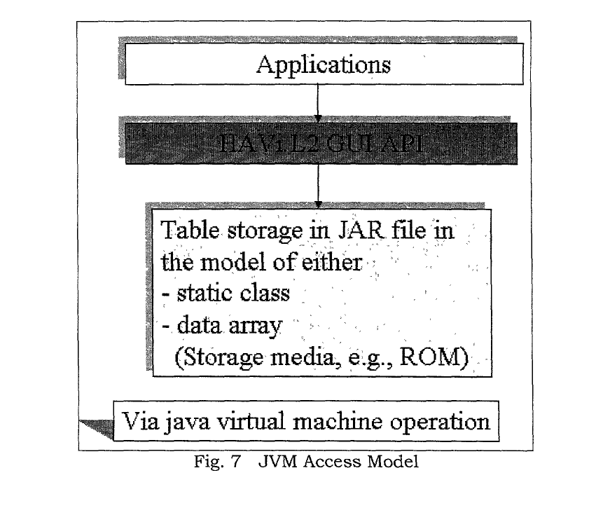

FIG. 8 is a representation of a Java I/O accessing model. This accessing model stores event representation data in a flash memory in text format. When virtual key information is required, the data is accessed by accessing an attribute in a file via a standard Java class, namely, the ResourceBundle. The ResourceBundle was originally invented by Java platform to support multiple language attributes. One advantage of this accessing model is that it permits a user to program some virtual key information, as opposed to accepting the de facto settings. For instance, a user can program the key representation of a color key, for example VK_COLOR_0, with a null string setting, to display some user-defined text on this color button. This is done by altering the event representation string field in the flash memory. The modification is permanent until next time the string is altered by user again. This model has high memory requirements, but absolutely no impact to API implementation. It is suitable for high-end feature enriched products.

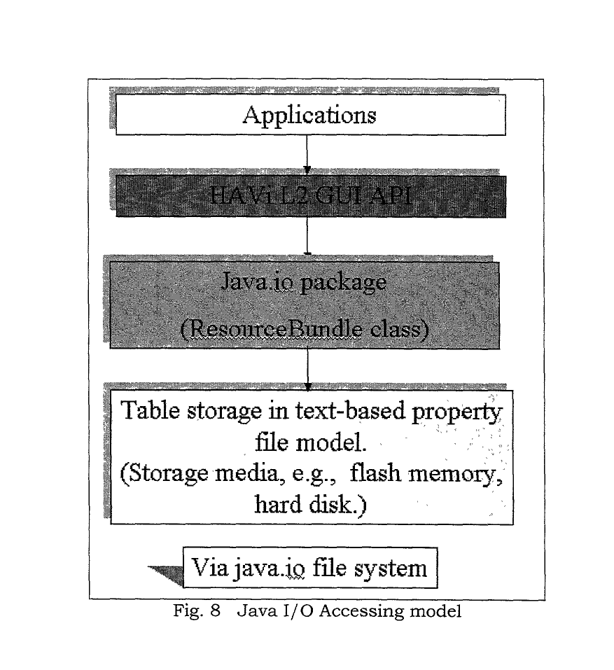

FIG. 9 is a representation of a JNI/storage driver accessing model. This accessing model requires intensive product design and programming, as each event representation field must be allocated an area in a mapped EEPROM memory. The JNI/storage driver model has fixed memory field size and compact data format (such as compressed or binary data). The HAVi L2 GUI access virtual key information via JNI calls to the storage driver. This model has low memory cost, high non-recurring design cost, limited design flexibility, and can implement user programmable features.

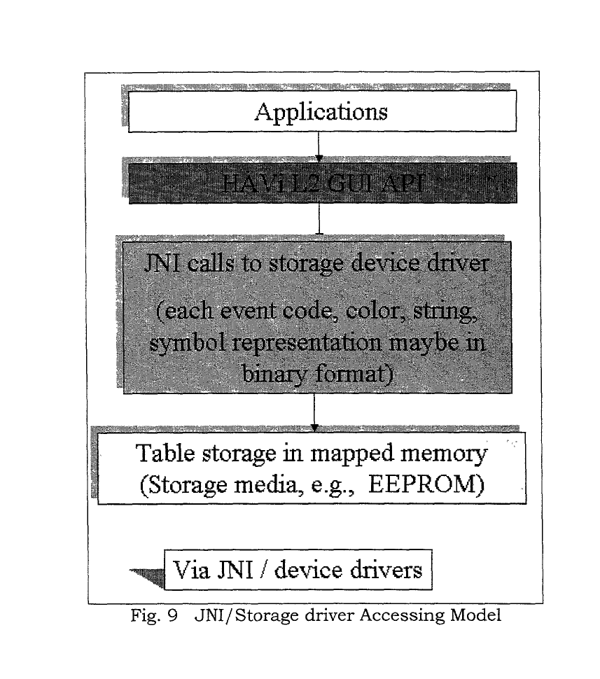

FIG. 10 is an example display of virtual keys created with string data and color data. Although not evident from the figure, the CK_0, CK_1, CK_2, and CK_3 are different colors, and the record key (REC) is red.

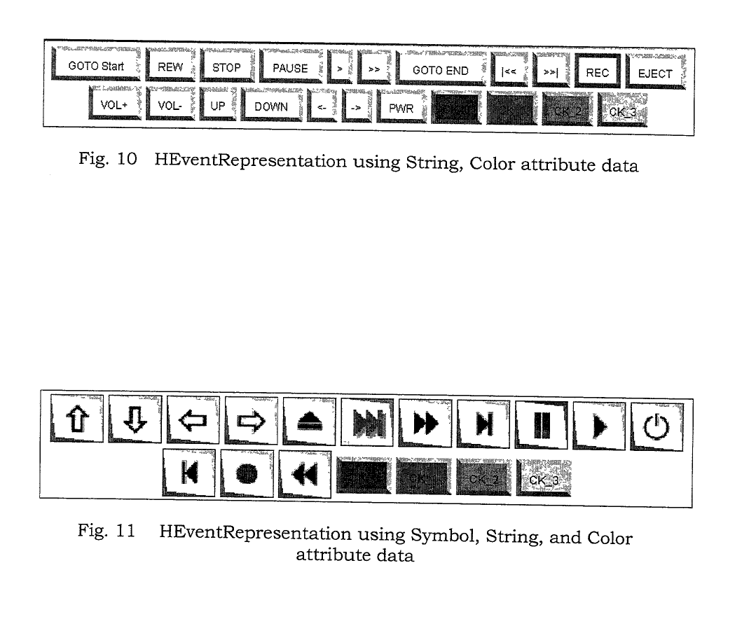

FIG. 11 is an example display of virtual keys using symbols data. Symbols data can be retrieved, in addition to string and color data, from the HEventRepresentation class by applications. Again, the CK_0, CK_1, CK_2, and CK_3 are different colors. Other keys may have colors associated with them.

A method for storing and accessing HEventRepresentation virtual key information has been provided. Example of specific storage mediums, protocols, and interfaces have been provided. However, the present invention is not limited to merely these examples. Other variations and embodiments of the invention will occur to those skilled in the art.

We claim:

1. In a device using HAVi specification protocols, a method for maintaining HEventRepresentation virtual keys, the method comprising:
from a HAVi level two (L2) graphical user interface (GUI), accessing a JAR file; and,
in response to accessing the JAR file, retrieving virtual key information.

2. The method of claim 1 wherein accessing a JAR file includes accessing a JAR file stored in read only memory (ROM).

3. The method of claim 2 wherein retrieving virtual key information includes retrieving virtual key information from a JAR file model selected from the group including static classes and data arrays.

4. The method of claim 3 wherein retrieving virtual key information in response to accessing the JAR file includes retrieving a HEventRepresentation application bundled with the virtual key information.

5. The method of claim 4 in which a first microprocessor machine using a first operating system is included;
the method further comprising:
receiving virtual key information as Java source code;
using a Java compiler, compiling the Java source code into Java virtual machine (JVM) byte codes for the first operating system; and,
using jar tools, archiving the JVM byte codes into a JAR file stored in ROM.

6. The method of claim 5 further comprising:
receiving the HEventRepresentation application as Java source code;
using a Java compiler, compiling the Java source code into Java virtual machine (JVM) byte codes for the first operating system; and,
using jar tools, archiving the JVM byte codes into a JAR file stored in ROM.

7. In a device using HAVi specification protocols, a method for maintaining HEventRepresentation virtual keys, the method comprising:
from a HAVi level two (L2) graphical user interface (GUI) accessing a Java input/output (I/O) ResourceBundle; and,
in response to accessing the ResourceBundle, retrieving virtual key information.

8. The method of claim 7 wherein accessing the ResourceBundle includes using a ResourceBundle application program interface (API) to specify a property file.

9. The method of claim 8 in which a first microprocessor machine using a first operating system is included;
the method further comprising:
maintaining a HEventRepresentation application in a protocol associated with the first operating system; and,
wherein accessing the ResourceBundle includes using a ResourceBundle API to specify a property file stored in a file system associated with the first microprocessor machine.

10. The method of claim 9 wherein using a ResourceBundle API to specify a property file stored in the file system includes specifying a property file stored in an input/output (I/O) device selected from the group of storage devices including hard disks and Flash memory.

11. The method of claim 10 further comprising:
receiving virtual key information as text-based properties attributes in a ResourceBundle property file;
integrating the virtual key information into a table of virtual key characteristics; and,
storing the virtual key characteristics table as the ResourceBundle property file.

12. In a device using HAVi specification protocols, a method for maintaining HEventRepresentation virtual keys, the method comprising:
from a HAVi level two (L2) graphical user interface (GUI) calling a Java native interface (JNI);
at the JNI, using Java byte codes to call a storage driver;
from the storage driver, accessing a mapped memory; and,
in response to accessing the mapped memory, retrieving virtual key information.

13. The method of claim 12 wherein accessing a mapped memory includes accessing a mapped memory stored in an electrically erasable programmable read only memory (EEPROM).

14. The method of claim 13 wherein retrieving virtual key information includes retrieving virtual key information from mapped memory in a binary format.

15. The method of claim 14 wherein using Java byte codes to call a storage driver at the JNI includes converting the Java byte code to binary format addresses; and,
wherein accessing a mapped memory from the storage driver includes using the binary format addresses to access ASCII codes stored in the EEPROM.

16. The method of claim 15 in which a first microprocessor using a first operating system is included;
the method further comprising:
receiving the storage driver as first operating system machine codes; and,
storing the storage driver as machine code.

17. The method of claim 16 further comprising:
receiving virtual key information as binary format code;
using the storage driver, cross-referencing the virtual key information with EEPROM addresses; and,
storing the virtual key information in the EEPROM as machine code.
